(19) United States
(12) Patent Application Publication
(10) Pub. No.: US 2010/0273000 A1
(43) Pub. Date: Oct. 28, 2010

(54) METAL NANOPARTICLE AND METHOD FOR PRODUCING THE SAME

(75) Inventors: Shuzo Tokumitsu, Kanagawa (JP); Takashi Narushima, Hokkaido (JP)

Correspondence Address: FROMMER LAWRENCE & HAUG, 745 FIFTH AVENUE- 10TH FL., NEW YORK, NY, 10151, US

(73) Assignee: HOYA CORPORATION, TOKYO (JP)

(21) Appl. No.: 12/738,716

(22) PCT Filed: Oct. 16, 2008
(86) PCT No.: PCT/JP2008/069173

§ 371 Date: Apr. 19, 2010

(30) Foreign Application Priority Data
Oct. 19, 2007 (JP) 2007-272447

(51) Int. Cl. B32B 15/02; B22F 9/18

(52) U.S. Cl. 428/403; 75/362

(57) ABSTRACT

A metal nanoparticle including, a core portion which includes at least one metal element, and organic compounds which adsorb onto the surface of the core portion. The organic compounds have a hydrophilic portion and a hydrophobic portion within their molecules. The hydrophilic portion is forming a coordinate bond with the surface of the core portion through O atoms.

The present application claims priority from PCT Patent Application No. PCT/JP2008/069173 filed on Oct. 16, 2008, which claims priority from Japanese Patent Application No. JP 2007-272447 filed on Oct. 19, 2007, the disclosure of which is incorporated herein by reference in its entirety.

### BACKGROUND OF THE INVENTION

1. Field of the Invention

The present invention relates to a metal nanoparticle and methods for fabricating a metal nanoparticle. Specifically, the present invention relates to a metal nanoparticle such that an organic compound having a hydrophilic portion and a hydrophobic portion within its molecule is forming coordinate bonds with the surface of the nanosized core part including at least one type of metallic element. Especially, the present invention relates to a magnetic nanocrystalline particle which is useful for high density recording mediums or magnetoresistive elements. Further, the present invention relates to a method of fabricating the metal nanoparticle, simply and inexpensively.

2. Description of Related Art

Since a magnetic material, such as FePt, FePd, and CoPt, shows a high crystalline magnetic anisotropy in the AuCu—I type L1₀ ordered phase, and since it can keep magnetically recorded information stably even if the particle diameter is less than or equal to 10 nm, it is receiving much attention as a material for a high density recording medium.

Recently, S. Sun, et al. reported an FePt nanoparticle which was fabricated with a chemical synthetic procedure (cf., S. Sun et al., Science, 287, (2000), p 1989). The surface of the FePt nanoparticle is covered with organic molecules, and it can be dispersed uniformly in an organic solvent. Thereafter, studies of an alloy nanoparticle, such as FePt, FePd, and CoPt, through a chemical synthetic procedure have been actively conducted.

The crystalline structure of FePt nanoparticles made using a chemical synthetic procedure is usually an face-centered cubic (fcc) structure, and it has been known that a phase transition occurs when it is heated at around 550° C.-700° C., where the phase transits to the L1₀ ordered phase.

Conventionally, as an FePt nanoparticle which is made using such a chemical synthetic procedure, the following are known. In S. Sun et al., Science, 287, (2000), p 1989, FePt nanoparticles are synthesized by reducing Fe and Pt salts with a reducing agent, such as polyol, in a high-boiling-point solvent in the presence of fatty acids and fatty amines, which act as an organic protective agent.

In Japanese Patent Provisional Publication No. 2006-249493A, a mixture of fatty acids and fatty amine, which acts as an organic protective agent, is added to metal salts, more than or equal to five times as much as the quantity of the metal salts in molar ratio, and the mixture of fatty acids and fatty amine is used as a solvent. The metal salts are reduced by adding, in addition, a reducing agent, such as polyol. Thereby, FePt nanoparticles are synthesized. Further, in Japanese Patent Provisional Publication 2001-292039A, an alcohol, which acts as a reducing agent, is used as a solvent. FePt nanoparticles are synthesized by adding, in addition, an organic protective agent, such as polyvinylpyrrolidone.

In order to manufacture devices such as a high density recording medium or a magnetoresistive device using the FePt nanoparticles made using the above methods, or to provide selective adsorption capacity to a cell or a biological macromolecule as a medical magnetic bead using the FePt nanoparticles made using the aforementioned method, it is necessary to introduce an organic protective molecule having an active functional group to the surface of the protective molecule of the nanoparticle so as to fix the nanoparticle to a substrate or to an antibody through chemical bonds, as it is disclosed in Japanese Patent Provisional Publication No. 2003-168606A.

In Japanese Patent Provisional Publication No. 2003-168606A, a surface of a metal core is covered with oxide, such as SiO₂. After that, the surface of the oxide is modified with a silane coupling agent having active functional groups, thereby introducing the active functional groups.

However, in this method, it is necessary to form an oxide layer on the surface of the metal core. Therefore, there are problems such that the magnetic characteristic intrinsic to the nanoparticle is degraded, or, the process of fabrication is complicated.

Therefore, it is preferable to introduce an organic protective molecule having an active functional group directly to the surface of the metal core. In this case, it is necessary that the nanoparticles are made by adding organic molecules having active functional groups, at the same time, in the process of fabricating the nanoparticles, or, it is necessary that organic molecules on the surfaces of the nanoparticles are replaced after fabricating the nanoparticles.

In the methods disclosed in S. Sun et al., Science, 287, (2000), p 1989, Japanese Patent Provisional Publication No. 2006-249493A, and Japanese Patent Provisional Publication No. 2001-292039A, the nanoparticles are fabricated by thermally decomposing or reducing metal salts or complexes, as raw materials, under a high temperature condition at or above 200° C. Hence, if the boiling point of an organic molecule having an active functional group is low, the reaction must be processed under a high pressure condition. Even if the boiling point is high, the active functional group is decomposed by heat. Thus, the original function cannot be performed. Therefore, it is not possible to fabricate the nanoparticles by adding organic molecules having active functional groups, at the same time, in the process of fabricating the nanoparticles.

Further, carboxylc acid, amine, and thiol, used in S. Sun et al. Science, 287, (2000), p 1989, and Japanese Patent Provisional Publication No. 2006-249493A, adhere to the surface of the metal core strongly through ion bonds (carboxylic acid), or, through coordinate bonds (amine, thiol). Therefore, it is difficult to replace these with organic molecules having active functional groups after fabricating the nanoparticles (cf., H. G. Bagaria et al., Langmuir, 22 (2006), p 7732).

Further, a water-soluble polymer, such as polyvinylpyrrolidone used in Japanese Patent Provisional Publication No. 2001-292039A, can be replaced with other organic protective molecule by extracting nanocrystals into a non-polar organic solvent, such as toluene, with a method of T. Tsukuda et al., MRS J., (2000), p929. However, the organic protective molecule that can be used in this case is limited to an organic protective molecule having a long-chain alkyl group, such as alkyl monocarboxylic acid, alkyl monoamine, or alkyl monothiol, which enables the nanoparticles to be extracted and dispersed stably in a non-polar organic solvent. Therefore, the surface of the nanoparticle is covered with an alkyl group that cannot form a chemical bond. Hence, the nanoparticle cannot form a chemical bond with a substrate or an antibody.

Further, in a conventional method, a large amount of a polar organic solvent such as alcohol or aceton is added to a reaction solution. Then, the synthesized nanoparticles are purified and isolated using the difference between solubility of unreacted ions or remaining organic substances and the solubility of the nanoparticles.

However, in the method of Japanese Patent Provisional Publication No. 2006-249493A, a selectable reagent is limited, because in order to obtain the alloy nanoparticles whose composition ratio of Fe and Pt is within the range in which a phase transition to the L1₀ ordered phase can occur, it is necessary to use long-chain fatty acids and long-chain fatty amines having higher boiling point than reduction temperature of metal salts as a mixture. Further, the polyols used as a reducing agent cannot reduce metal salts sufficiently, if they are not mixed with the fatty acids and the fatty amines to be used. Therefore, it is necessary to prepare a reducing agent adjusted to the fatty acids and the fatty amines to be used, separately.

In the method of Japanese Patent Provisional Publication No. 2001-292039A, the reaction is performed in alcohol. Thus, it is necessary to prepare an alcohol-soluble organic protective agent, separately.

It is not preferable to use a large amount of a polar solvent for purifying and isolating the nanocrystals, since it is expensive to process the waste solution and the waste gas. Furthermore, it is not preferable from the viewpoint of the environmental aspect.

### SUMMARY OF THE INVENTION

The present invention is achieved under the circumstances described above. An objective of the present invention is to provide a metal nanoparticle such that an arbitrary functional organic molecule can be introduced to the surface of the metal core in a post-process after the fabrication of the metal nanoparticle, while retaining the dispersibility in a solvent of the metal nanoparticle. Further, objectives of the present invention are to provide a novel metal nanoparticle which can be produced without separately using an organic solvent, a reducing agent, or an organic protective agent, and which can be produced inexpensively by a simple operation which gives a small impact on the environment; to provide, especially, a magnetic alloy nanoparticle useful for a high density recording medium, a magnetoresistive device, and a medical magnetic bead; and to provide a method of fabricating the metal nanoparticle.

As a result of researches to achieve the above objectives, the inventors of the present invention have found that it is possible to accomplish the objectives by a metal nanoparticle and, especially, by a magnetic alloy nanocrystalline particle such that organic compounds having a hydrophilic portion and a hydrophobic portion within their molecules are forming coordinate bonds with the surface of the core portion including at least one metallic element through O atoms of ether groups, ketone groups, or hydroxyl groups of the hydrophilic portion. Further, the inventors of the present invention have found that by using organic compounds having a hydrophilic portion and a hydrophobic portion within their molecules, the metal nanoparticle can be produced inexpensively by a simple operation which gives a small impact on the environment. The present invention has been accomplished based on this knowledge.

Namely, the present invention provides:
(1) a metal nanoparticle including: a core portion which includes at least one metal element; and organic compounds which adsorb onto the surface of the core portion, wherein the organic compounds have a hydrophilic portion and a hydrophobic portion within their molecules, and wherein the hydrophilic portion is forming a coordinate bond with the surface of the core portion through O atoms;
(2) a metal nanoparticle including: a core portion which includes at least one metal element; and organic compounds which adsorb onto the surface of the core portion, wherein the organic compounds have a hydrophilic portion and a hydrophobic portion within their molecules, and wherein the hydrophilic portion combines with the surface of the core portion through O atoms of an ether group, a ketone group, or a hydroxyl group;
(3) the metal nanoparticle according to one of (1) or (2) described above, wherein the hydrophilic portion of the organic compounds include at least one hydroxyl group; (4) the metal nanoparticle according to one of (1)-(3) described above, wherein the organic compounds include R(OCH₂CH₂)ₙOH, (R: a functional group including an alkyl group, n≧1); (5) the metal nanoparticle according to one of (1)-(4) described above, wherein the core portion includes at least one metal element belonging to 3rd-10th groups in the 4th period of the periodic table (long form) and at least one element belonging to the platinum group elements;
(6) the metal nanoparticle according to (5) described above, wherein the at least one metal element belonging to 3rd-10th groups in the 4th period is selected from at least one of Fe, Co, or Ni;
(7) the metal nanoparticle according to (6) described above, wherein the core portion includes Fe and/or Co, and, Pd and/or Pt; (8) a method of fabricating the metal nanoparticle according to (1) or (2) described above, wherein the method includes: (a) a process of preparing a solution of the organic compounds by dissolving salts or complexes of the at least one metal element in the organic compounds having the hydrophilic portion and the hydrophobic portion; and (b) a process of producing metal nanocrystals including the at least one metal element by heating the solution of the organic compounds at around 150-320° C.;
(9) the method of fabricating the metal nanoparticle according to (8) described above, wherein, following process (b), the method further includes: (c) a process of precipitating and separating the metal nanocrystals by adding water to the reaction solution including the metal nanocrystals;
(10) the method of fabricating the metal nanoparticle according to (8) or (9) described above, wherein the salts or complexes of the at least one metal element used in process (a) are a chloride, a sulfate, a nitrate, a carboxylate, an acetylacetonato complex, an ethylenediamine complex, an ammine complex, a cyclopentadienyl complex, or a triphenylphosphine complex;
(11) the method of fabricating the metal nanoparticle according to one of (8)-(10) described above, wherein the hydrophobic portion of the organic compounds having the hydrophilic portion and the hydrophobic portion used in the process (a) include an alkyl group with a carbon number of greater than or equal to 6, and wherein the organic compounds having the hydrophilic portion and the hydrophobic portion include at least one hydroxyl group within their molecules; and
(12) the method of fabricating the metal nanoparticle according to (8)-(11) described above, wherein the organic compounds include R(OCH₂CH₂)ₙOH, (R: a functional group including an alkyl group, n≧1).

According to the present invention, it is possible to provide a metal nanoparticle such that organic compounds having a hydrophilic portion and a hydrophobic portion are forming a coordinate bonding with the surface of the nanosized core part including at least one metal element through O atoms in the hydrophilic portion. Especially, it is possible to provide a magnetic nanoparticle which is useful for a high density recording medium or a magnetoresistive element.

Further, according to a method of fabrication of the present invention, by using organic compounds having a hydrophilic portion and a hydrophobic portion within its molecule, the metal nanoparticle can be produced inexpensively by a simple process which gives a small impact on the environment.

### BRIEF DESCRIPTION OF THE DRAWINGS

FIG. 1 is a diagram showing structures of chemical compounds used in embodiments of the present invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

First, a metal nanoparticle of the present invention is explained.

Metal Nanoparticle:

A metal nanoparticle according to the present invention includes a core portion including at least one metal element and organic compounds which adhere to the surface of the core portion. The organic compounds have a hydrophilic portion and a hydrophobic portion within their molecules, and the hydrophilic portion combines with the surface of the core portion through O atoms of ether groups, ketone groups, or hydroxyl groups. An ether group, a ketone group, or a hydroxyl group enable that the bond between each O atom of the respective groups and the surface is a coordinate bond.

Core Portion:

A core portion of a metal nanoparticle of the present invention is a nanosized core portion. It is preferable that the core portion includes at least one metal element belonging to 3rd-10th groups in the 4th period of the periodic table (long form) and at least one element belonging to the platinum group elements. It is more preferable that the core portion is an alloy including Fe and/or Co, and Pd and/or Pt. Conventionally, in a metal nanoparticle including a metal element belonging to 3rd-10th groups in the 4th period in its core portion, a carboxylate ion has been used for a connecting portion which connects to the core portion. Since a carboxylate ion forms a strong ion bond with an element belonging to 3rd-10th groups in the 4th period, it can be said that an organic compound having a carboxylate ion in a connecting portion (an organic ligand) is a preferred organic compound for producing a metal nanocrystalline having a solvent dispersibility. However, an organic compound which forms “a strong ion bond,” such as a carboxylate ion, is not preferred for the case in which an organic compound combining with the metal core portion is to be replaced with another organic protective agent. On the other hand, in a structure according to the present invention, a connecting portion between a metal core portion of a metal nanoparticle and an organic compound (an organic ligand) is formed by a coordinate bond through neutral O atoms of ether groups, ketone groups, or hydroxyl groups. Since a coordinate bond is relatively weak in comparison with an ion bond, it is easy to replace it with another organic compound (an organic protective agent). Namely, a structure according to the present invention is particularly effective for a metal nanoparticle having a metal element belonging to 3rd-10th groups in the 4th period of the periodic table (long form) in its core portion. Further, regarding a coordinate bond according to the present invention, it is described that “the bond is weak.” This implies that it is easy to remove the bond when an effect has been received from outside (e.g., an addition of an organic compound which can form an ion bond with the metal core portion). It does not imply that the organic compound tends to be removed naturally from the metal core portion. As described below, in a structure according to the present invention, an organic compound can be combined with a surface of a metal core portion at multiple points. Thus, it is rare that a natural desorption occurs. Namely, a structure of the present invention is excellent in handling such that in a relationship between a surface of a metal core portion and an organic compound, a natural desorption does not occur and the organic compound can be easily replaced.

The metal elements belonging to the 3rd-10th groups in the 4th period of the periodic table (long form) are Sc, Ti, V, Cr, Mn, Fe, Co, and Ni. It is preferable that, for the elements, at least one metal element is selected from Fe, Co, and Ni among the aforementioned elements. On the other hand, the platinum group elements are Ru, Rh, Pd, Os, Ir, and Pt. At least one element among the aforementioned elements is used. Since elements belonging to 3rd-10th groups in the 4th period show magnetic properties when they form an alloy by themselves or with platinum elements, they can be useful row materials for a high density magnetic recording medium or a magnetoresistive element.

As an alloy forming the core portion, an alloy including Fe and/or Co, and Pd and/or Pt is especially preferable. Such an alloy is a magnetic alloy useful for a high density magnetic recording medium or a magnetoresistive element.

Further, the alloy can include, as third metal elements, one element selected from Ag, Cu, Sb, Bi, and Pb. Such an alloy including a third metal element has an effect that the temperature of the phase transition to the L1₀ ordered structure is lowered.

In a metal nanoparticle according to the present invention, depending on its usage, the average particle radius of the core portion is around 1-15 nm, preferably 3-10 nm, and more preferably 4-8 nm, from the viewpoint of solvent-dispersibility or easiness of handling. As its usage, for example, when a nanoparticle is used as a magnetic particle, it is preferable that the average particle radius of the core portion is around 4-8 nm.

Organic Compound:

In a metal nanoparticle according to the present invention, an organic compound adhering to the surface of the core portion has a structure such that a hydrophilic portion and a hydrophobic portion are included in its molecule, while the hydrophilic portion is forming a coordinate bond with the surface of the core portion through O atoms. Here, by including ether groups, ketone groups, or hydroxyl groups in the hydrophilic portion, the bond between O atoms of each of these groups and the surface of the core portion can be a coordinate bond.

The hydrophilic portion combines with the surface of the core portion through O atoms of ether groups, ketone groups, or hydroxyl groups included in the hydrophilic portion. By including ether groups, ketone groups, or hydroxyl groups, it is possible that the hydrophilic portion combines with the surface of the core portion at more than two points. It is not necessary that the hydrophilic portion always combines with the surface of the core portion at two points. However, when the hydrophilic portion combines with the surface of the core portion at more than two points, even if one of the bonds is released, the other bond remains. Thus, there are some possibilities that bonds are formed again at more than two points. Therefore, it is possible to reduce the possibility that the organic compound is separated from the surface of the core portion. In a situation in which the hydrophilic portion combines with the surface of the core portion at only one point, if the only one bone is released, the organic compound separates from the surface of the core portion and the organic compound is dispersed in a solvent. Namely, with only one bond, the possibility of combining again the organic compound, which has separated once, with the surface of the core portion is extremely low. Therefore, the density of the organic compounds on the surface of the core portion cannot be retained. Consequently, the solvent dispersibility of the metal nanoparticle cannot be retained. From the viewpoint of the solvent dispersibility, it is very important to combine the hydrophilic portion with the surface through ether groups, ketone groups, or hydroxyl groups, as in the case of the present invention.

As the organic compound, an organic compound having a carbon number greater than or equal to 6, having a hydrophobic portion preferably including 8-24 alkyl groups, and having at least one hydroxyl group, is preferable. The reason that the carbon number is limited to be greater than or equal to 6 is that if the carbon number is less than 6, then the length of the hydrophobic portion is not long enough and dispersibility in non-polar solvents is not obtained. Thus, it is more preferable that the carbon number is greater than or equal to 8. On the other hand, if the carbon number is greater than 24, the fluidity of the organic compound is hard to obtain. Its usability in experiments is poor and it is impractical. Thus, it is more preferable that the carbon number is less than or equal to 24. Having a hydroxyl group, the organic compound can act as an reduction agent. For such an organic compound, the following are preferable: polyoxyethylene alkyl ether, polyoxyethylene alkyl-carboxylic acid ester, alkyl glucopyranoside, alkyl maltoside, polyoxyethylene sorbitan monoalkyl ester, for example.

Among these, it is preferable that the hydrophilic portion is an ethylene glycol group or a polyethyleneglycol group having an hydroxyl group at its end. For example, polyoxyethylene alkyl ether, polyoxyethylene alkyl-carboxylic acid ester, and polyoxyethylene sorbitan monoalkyl ester are preferable. These organic compounds can be represented such that an organic compound according to the present invention includes R(OCH₂CH₂)ₙOH, (R: a functional group including an alkyl group, n≧1).

An alkyl group with a carbon number greater than or equal to 6, which is included in the hydrophobic portion of the organic compound, can be a straight-chain type, a branched-chain type, or a cyclic type. The following are examples of an alkyl group with a carbon number greater than or equal to 6: various types of hexyl groups, various types of heptyl groups, various types of octyl groups, various types of decyl groups, various types of dodecyl groups, various types of tetradecyl groups, various types of hexadecyl groups, various types of octadecyl groups, various types of icosyl groups, a cyclohexyl ethyl group, a cyclohexyl propyl group. An alkyl group with a carbon number ranging from 8 to 24 is preferable. Therefore, it is possible to prevent metal nanoparticles from condensing each other.

A metal nanoparticle according to the present invention is such that the organic compounds are forming coordinate bonds with the surface of the core portion through the hydrophilic portions of the organic compounds. Therefore, it is possible to prevent metal nanoparticles from condensing each other. Since the hydrophobic portion is placed outwardly from the metal nanoparticle, the metal nanoparticle can have an excellent solvent-dispersibility in a organic solvent with small polarity. Therefore, the organic compounds act as an organic protective agent.

Here, bonds between a core portion of a metal nanoparticle according to the present invention and organic compounds adhering to the surface of the core portion are explained. They are combining with each other through coordinate bonds. Specifically, a metal atom on the surface of the core portion combines with a hydrophilic portion of the organic compounds by receiving a lone electron pair of neutral O atoms of ether groups, ketone groups, or hydroxyl groups which resides in polyoxyethylene chain or an ester combining portion of the organic compound adhering to the surface of the core portion. Further, a coordinate bond through neutral O atoms of ether groups, ketone groups, or hydroxyl groups is weak in comparison with a coordinate bond through an atom such as N, S, or P which can be found in a conventional metal nanoparticle. When the organic compound has only one neutral O atom in the hydrophilic portion, the coordinate bond breaks easily, thereby the organic compound separates from the surface of the metal core. Therefore, the metal nanoparticle cannot retain a good dispersed state in a solvent. However, organic compounds included in a metal nanoparticle according to the present invention have plural O atoms in the hydrophilic portion. Thus, the core portion and the organic compound can form plural bonding points (a structure with which bonds can be formed at two or more points). In a metal nanoparticle according to the present invention, the core portion and the organic compounds combine stably with each other. With this stable bond, the metal nanoparticle can retain a good dispersed state in a solvent.

Further, it can be considered as one of the characteristics of a metal nanoparticle according to the present invention that organic compounds adhering to the surface of the core portion can be replaced with other organic compounds.

In conventional metal nanoparticles, a core portion and an organic compound adhering to the surface of the core portion are combining with each other by a coordinate bond through an atom such as N, S, or P, or by an ionic bond through an anionic O atom of a carboxylate ion. Each of elements N, S, P combines very strongly with a platinum group element by a coordinate bond. Therefore, when producing a metal nanoparticle including one or more platinum group elements, if an organic protective agent adhering to the surface of the core portion of a metal nanoparticle through an atom of N, S, or P, then after producing the metal nanoparticle, the organic protective agent cannot be replaced with another organic protective agent. Thus it is difficult to introduce various functional organic molecules to the surface of the metal nanoparticle, and it can be an obstacle to design a metal nanoparticle. As organic protective agents adhering to the surface of the core portion of the metal nanoparticle through an atom of N, S, or P, the following can be considered: amine, thiol, phosphine, nitryl, and pyridine.

Further, since a carboxylate ion forms a strong ion bond with an element belonging to 3rd-10th groups in the 4th period, it cannot be replaced with another organic protective agent, similarly, after a metal nanoparticle is produced. Thus, it is difficult to introduce various functional organic molecules to the surface of the metal nanoparticle.

However, in a metal nanoparticle according to the present invention, organic compounds are adhering to the surface of the core portion by a coordinate bond through neutral O atoms of ether groups, ketone groups, or hydroxyl groups in the hydrophilic portion of the organic compounds themselves. Since these bonds are relatively weak irrespective of kinds of metals, they can be easily replaced with other organic compounds. For example, the organic compound adhering to the surface of the core portion can be replaced with an organic compound such as amine, carboxyl acid, thiol, phosphine, nitril, and pyridine. After the replacement, the metal nanoparticle becomes a metal nanoparticle such that the surface of the core portion is protected by the replaced organic compound. The replacement is caused by the weakness of the coordinate bond between the core portion and the O atoms in the hydrophilic portion of the organic compounds, relative to the bond between the core portion and an organic compound such as an amine, a carboxyl acid, a thiol, a phosphine, a nitril, and a pyridine.

Next, a method of fabricating a metal nanoparticle according to the present invention is explained.

Method of Fabricating Metal Nanoparticle:

There is no particular restriction for a method of fabricating a metal nanoparticle, as long as the nanoparticle with the above described property can be obtained. However, according to a method according to the present invention described below, the desired metal nanoparticle can be produced inexpensively by a simple operation with a small impact on the environment.

As one of characteristics, a method of fabricating a metal nanoparticle includes the following processes: (a) a process of preparing a solution of organic compounds having a hydrophilic portion and a hydrophobic portion within their molecules by adding and dissolving salts or complexes of at least one metal element to the organic compounds, (b) a process of forming metal nanocrystals including at least one metal element by heating the solution of the above organic compounds at around 150-320° C. Depending on a case, the method further includes the following process: (c) a process of separating the metal nanocrystals by adding water to the reaction liquid including the metal nanocrystals and precipitating the metal nanocrystals.

Process (A):

Process (a) is a process of preparing a solution of organic compounds having a hydrophilic portion and a hydrophobic portion within the organic compounds by adding and dissolving salts or complex of at least one metal element to the organic compounds.

The organic compounds having the hydrophilic portion and the hydrophobic portion used in process (a) are in accordance with the organic compounds explained with the explanation of the above metal nanoparticles.

In a method according to the present invention, since salts or complexes of metal elements are dissolved in organic compounds and metal nanocrystals are formed by heating, organic compounds having a melting point lower than or equal to 100° C. are preferable as the organic compounds, and organic compounds having a melting point lower than or equal to 40° C. are more preferable.

In a method according to the present invention, the organic compounds are having a function as a solvent, a function as a reducing agent, and a function as an organic protective agent, simultaneously.

When a molecular weight of an organic compound having a hydrophilic portion and a hydrophobic portion within its molecule is heavy, the viscosity significantly increases. When an organic compound with a high viscosity is adopted, it can be an obstacle for dissolving salts or complexes in the organic compounds at process (a) described below. In this case, the viscosity of the solution of the organic compound can be adjusted by mixing other organic compounds having low viscosities, which do not give any influence to the adhesion of the hydrophilic portion of the organic compound to the surface of the core portion of the metal nanoparticle. As such organic compounds to be mixed for adjusting the solution, the following can be considered: octadecene and tetraethyleneglycol, for example. In this manner, by mixing organic compounds having low viscosities, such a process can be facilitated. Further, as organic compounds to be mixed, organic compounds having a higher boiling point than the heating temperature of process (b) described below are preferable. This is because if the boiling point of the organic compounds to be mixed is lower than the heating temperature of process (b) described below, then at the heating of process (b) described below, the temperature cannot be raised to a desired temperature. Further, by mixing other organic compounds, in the solution including the organic compounds to be combined with surfaces of core portions of metal nanoparticles and other organic compounds, the percentage of the former organic compounds is lowered. It follows that the concentration of reduced metals increases (the frequency of the occasions in which the organic compounds adhering to the surfaces of the core portions adhere to the core portions decreases), when forming core portions of the metal nanoparticles produced at process (b) described below. Thus, it is possible to control the sizes of the metal nanoparticles. Further, it is preferable that the mixing ratio of the other organic compounds is less than or equal to 80 percent in weight, taking into consideration of the dispersibility of the produced metal nanoparticles. Furthermore, it is more preferable that the mixing ratio of the other organic compounds is less than or equal to 70 percent in weight.

Further, in process (a), as the salts or complexes of metal elements, the following can be considered: a chloride, a sulfate, a nitrate, a carboxylate, an acetylacetonato complex, an ethylenediamine complex, an amine complex, a cyclopentadienyl complex, or a triphenylphosphine complex, and a π-allyl complex. In a method according to the present invention, salts or complexes of at least one metal element are used. However, from the viewpoint of forming alloy nanocrystalline particles, it is preferable to use a combination of salts or complexes of at least one metal element belonging to 3rd-10th groups in the 4th period of the periodic table (long form) and salts or complexes of at least one element belonging to the platinum group elements. Further, from the viewpoint of forming magnetic alloy nanocrystalline particles, it is preferable to use a combination of salts or complexes of at least one element selected from Fe, Co, and Ni and salts or complexes of at least one element belonging to the platinum group elements. It is more preferable to use a combination of salts or complexes of Fe and/or Co and salts or complexes of Pd and/or Pt.

Further, in a method according to the present invention, along with the salts or complexes of the above metal elements, salts or complexes of at least one element selected from Ag, Cu, Sb, Bi and Pb can be used concurrently. In a method according to the present invention, there is no restriction to the amount of salts or complexes of the total metal elements with respect to the organic compounds. However, normally, around 0.1-30 mmol of salts or complexes of the total metal elements are added to 100 ml of the organic compounds. It is preferable to add 0.5-5 mmol of salt or complexes of the total metal elements, and it is more preferable to add 0.8-2 mmol of salt or complexes of the total metal elements.

Further, when a combination of salts or complexes of Fe and/or Co and salts or complexes of Pd and/or Pt is used, it is preferable that the percentages of the uses of the former and the latter are almost equal to the stoichiometric quantities so that alloy nanocrystalline particles of a desired composition can be produced.

Process (B):

Process (b) is a process of forming metal nanocrystals including at least one metal element by heating the solution of the organic compounds prepared in process (a) above at a temperature of 150-320° C. When the heating temperature is lower than 150° C., the reduction of the metal salts does not occur sufficiently. Further, the rate of reaction is slow and it is not practical. When the heating temperature is higher than 320° C., it is possible that degradation of the organic compounds occur. It is preferable that the heating temperature is a temperature of 180-310° C., and it is more preferable that the heating temperature is within the range of 200-300° C. Further, the heating duration depends on the heating temperature, thus the heating duration cannot be determined uniformly. However, the heating duration is normally 5-300 minutes, preferably 10-120 minutes, and more preferably 30-60 minutes. Further, it is preferable that the reaction is performed under an inert gas atmosphere such as nitrogen gas or argon gas.

Process (c) is applied when it is necessary. Process (c) is a process of precipitating the metal nanocrystals and separating the metal nanocrystals from the reaction solution by adding water to the reaction solution including the metal nanocrystals, after finishing process (b) above.

An organic compound used in a method according to the present invention has a hydrophilic portion and is miscible in water. Thus, by adding water to the reaction solution, the metal nanocrystals easily form precipitations. Therefore, it is possible to take out the metal nanocrystals by using a conventionally known separating means for separating solids from liquid, and the metal nanocrystals can be dried.

The metal nanoparticle thus obtained is such that the organic compound is forming a coordinate bond with the surface of the core portion through O atoms in the hydrophilic portion and the hydrophobic portion of the organic compounds is placed outwardly from the metal nanoparticle. Thus, the metal nanoparticle can be dispersed easily in a weakly polarized organic solvent such as toluene. The organic compounds adhering to the surface of the core portion can be replaced easily with organic compounds such as an amine, a carboxyl acid, a thiol, a phosphine, and a pyridine.

Further, when the obtained metal nanoparticles are FePt, CoPt, or FePd alloy nanocrystalline particles, usually, their crystal structures are face-centered cubic (fcc). When the nanocrystalline particles are heated at a temperature of 550° C.-700° C., the crystal experiences a phase transition to the L1₀ ordered phase.

### EMBODIMENTS

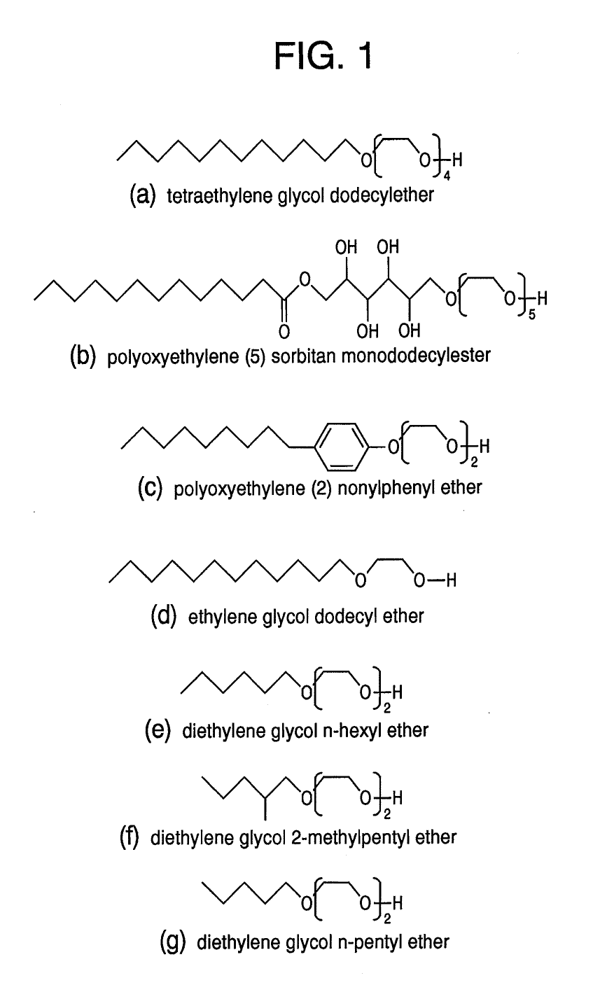

Hereinafter, the present invention is explained in detail using embodiments. However, the present invention is not limited to these embodiments. Further, structural formulas of organic compounds used in respective embodiments and reference examples are shown in FIG. 1.

### Embodiment 1

First, 40 mg of tris(acetylacetonato)iron (III) and 44 mg of bis(acetylacetonato)platinum (II) are added to 20 ml of tetraethylene glycol dodecylether (cf., FIG. 1, including an alkyl group with carbon number 12) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of FePt nanocrystals, whose surfaces are protected by tetraethylene glycol dodecyl ether, is prepared. After 0.5 M of aqueous solution of mercaptosuccinic is added to 10 ml of the toluene dispersion liquid, it is agitated for one hour at ambient temperature. Then FePt nanocrystals shift from a toluene phase to a water phase. It is verified by the FT-IR measurement that as an organic molecule protecting the surface of the FePt nanocrystal thus obtained, tetraethylene glycol dodecyl ether is replaced by mercaptosuccinic. Table 1 shows the results of measurements of the composition ratios of the obtained nanocrystals using inductively-coupled plasma atomic emission spectroscopy. Further, Table 1 shows the average particle diameter extracted by observing the particle images of the obtained nanocrystals using a transmission electron microscope. Further, it is verified by X-ray diffraction that the obtained nanocrystals experience phase transitions to the L1₀ phase, when the obtained nanocrystals are heated at 700° C. for 30 minutes in a vacuum of 1.33×10⁻³ Pa.

### Embodiment 2

First, 40 mg of tris(acetylacetonato)cobalt (III) and 44 mg of bis(acetylacetonato)platinum (II) are added to 20 ml of tetraethylene glycol dodecylether (cf., FIG. 1, including an alkyl group with carbon number 12) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of CoPt nanocrystals whose surfaces are protected by tetraethylene glycol dodecyl ether is prepared. After 0.5 M of aqueous solution of mercaptosuccinic is added to 10 ml of the toluene dispersion liquid, it is agitated for one hour at ambient temperature. Then CoPt nanocrystals shift from a toluene phase to a water phase. It is verified by the FT-IR measurement that as an organic molecule protecting the surface of the CoPt nanocrystal thus obtained, tetraethylene glycol dodecyl ether is replaced by mercaptosuccinic. Table 1 shows the results of investigations of the composition ratios and the average particle diameter using the same methods as in Embodiment 1. Further, it is verified by X-ray diffraction that the obtained nanocrystals experience phase transitions to the L1₀ phase, when the obtained nanocrystals are heated at 700° C. for 30 minutes in a vacuum of 1.33×10⁻³ Pa.

### Embodiment 3

First, 31 mg of ferric chloride (III) hexahydrate and 20 mg of palladium chloride (II) are added to 20 ml of polyoxyethylene (5) sorbitan monododecylester (cf., FIG. 1, including an alkyl group with carbon number 12) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of FePd nanocrystals whose surfaces are protected by polyoxyethylene (5) sorbitan monododecylester is prepared. After 0.5 M of aqueous solution of mercaptosuccinic is added to 10 ml of the toluene dispersion liquid, it is agitated for one hour at ambient temperature. Then FePd nanocrystals shift from a toluene phase to a water phase. It is verified by the FT-IR measurement that as an organic molecule protecting the surface of the FePd nanocrystal thus obtained, polyoxyethylene (5) sorbitan monododecylester is replaced by mercaptosuccinic. Table 1 shows the results of investigations of the composition ratios and the average particle diameter using the same methods as in Embodiment 1. Further, it is verified by X-ray diffraction that the obtained nanocrystals experience phase transitions to the L1₀ phase, when the obtained nanocrystals are heated at 700° C. for 30 minutes in a vacuum of 1.33×10⁻³ Pa.

### Embodiment 4

First, 15 mg of cobalt chloride (H) and 20 mg of palladium chloride (II) are added to 20 ml of polyoxyethylene (5) sorbitan monododecylester (cf., FIG. 1, including an alkyl group with carbon number 12) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of CoPd nanocrystals whose surfaces are protected by polyoxyethylene (5) sorbitan monododecylester is prepared. After 0.5 M of aqueous solution of mercaptosuccinic is added to 10 ml of the toluene dispersion liquid, it is agitated for one hour at ambient temperature. Then CoPd nanocrystals shift from a toluene phase to a water phase. It is verified by the FT-IR measurement that as an organic molecule protecting the surface of the CoPd nanocrystal thus obtained, polyoxyethylene (5) sorbitan monododecylester is replaced by mercaptosuccinic. Table 1 shows the results of investigations of the composition ratios and the average particle diameter using the same methods as in Embodiment 1.

### Embodiment 5

First, 58 mg of tris(acetylacetonato)cobalt (II) is added to 20 ml of polyoxyethylene (2) nonylphenyl ether (cf., FIG. 1, including an alkyl group with carbon number 9) and it is heated at 250° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of Co nanocrystals whose surfaces are protected by polyoxyethylene (2) nonylphenyl ether is prepared. After 0.5 M of aqueous solution of mercaptosuccinic is added to 10 ml of the toluene dispersion liquid, it is agitated for one hour at ambient temperature. Then Co nanocrystals shift from a toluene phase to a water phase. It is verified by the FT-IR measurement that as an organic molecule protecting the surface of the Co nanocrystal thus obtained, polyoxyethylene (2) nonylphenyl ether is replaced by mercaptosuccinic. Table 1 shows the results of investigations of the composition ratios and the average particle diameter using the same methods as in Embodiment 1.

### Embodiment 6

First, 88 mg of tris(acetylacetonato)platinum (II) is added to 20 ml of polyoxyethylene (2) nonylphenyl ether (cf., FIG. 1, including an alkyl group with carbon number 9) and it is heated at 200° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of Pt nanocrystals whose surfaces are protected by polyoxyethylene (2) nonylphenyl ether is prepared. After 0.5 M of aqueous solution of mercaptosuccinic is added to 10 ml of the toluene dispersion liquid, it is agitated for one hour at ambient temperature. Then Pt nanocrystals shift from a toluene phase to a water phase. It is verified by the FT-IR measurement that as an organic molecule protecting the surface of the Pt nanocrystal thus obtained, polyoxyethylene (2) nonylphenyl ether is replaced by mercaptosuccinic. Table 1 shows the results of investigations of the composition ratios and the average particle diameter using the same methods as in Embodiment 1.

### Embodiment 7

First, 68 mg of tris(acetylacetonato)palladium (II) is added to 20 ml of polyoxyethylene (2) nonylphenyl ether (cf., FIG. 1, including an alkyl group with carbon number 9) and it is heated at 200° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of Pd nanocrystals whose surfaces are protected by polyoxyethylene (2) nonylphenyl ether is prepared. After 0.5 M of aqueous solution of mercaptosuccinic is added to 10 ml of the toluene dispersion liquid, it is agitated for one hour at ambient temperature. Then Pd nanocrystals shift from a toluene phase to a water phase. It is verified by the FT-IR measurement that as an organic molecule protecting the surface of the Pd nanocrystal thus obtained, polyoxyethylene (2) nonylphenyl ether is replaced by mercaptosuccinic. Table 1 shows the results of investigations of the composition ratios and the average particle diameter using the same methods as in Embodiment 1.

### Embodiment 8

First, 40 mg of tris(acetylacetonato)iron (III), 44 mg of bis(acetylacetonato)platinum (II) and 12 mg of mono(acetylacetonato)silver (I) are added to 20 ml of tetraethylene glycol dodecylether (cf., FIG. 1, including an alkyl group with carbon number 12) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of FePtAg nanocrystals whose surfaces are protected by tetraethylene glycol dodecyl ether is prepared. After 0.5 M of aqueous solution of mercaptosuccinic is added to 10 ml of the toluene dispersion liquid, it is agitated for one hour at ambient temperature. Then FePtAg nanocrystals shift from a toluene phase to a water phase. It is verified by the FT-IR measurement that as an organic molecule protecting the surface of the FePtAg nanocrystal thus obtained, tetraethylene glycol dodecyl ether is replaced with mercaptosuccinic. Table 1 shows the results of investigations of the composition ratios and the average particle diameter using the same methods as in Embodiment 1. Further, it is verified by X-ray diffraction that the obtained nanocrystals experience phase transitions to the L1₀ phase, when the obtained nanocrystals are heated at 450° C. for 300 minutes in a vacuum of 1.33×10⁻³ Pa.

### Embodiment 9

First, 40 mg of tris(acetylacetonato)cobalt (III), 44 mg of bis(acetylacetonato)platinum (H) and 22 mg of lead acetate (II) trihydrate are added to 20 ml of tetraethylene glycol dodecylether (cf., FIG. 1, including an alkyl group with carbon number 12) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of CoPtPb nanocrystals whose surfaces are protected by tetraethylene glycol dodecyl ether is prepared. After 0.5 M of aqueous solution of mercaptosuccinic is added to 10 ml of the toluene dispersion liquid, it is agitated for one hour at ambient temperature. Then CoPtPb nanocrystals shift from a toluene phase to a water phase. It is verified by the FT-IR measurement that as an organic molecule protecting the surface of the CoPtPb nanocrystal thus obtained, tetraethylene glycol dodecyl ether is replaced by mercaptosuccinic. Table 1 shows the results of investigations of the composition ratios and the average particle diameter using the same methods as in Embodiment 1. Further, it is verified by X-ray diffraction that the obtained nanocrystals experience phase transitions to the L1₀ phase, when the obtained nanocrystals are heated at 450° C. for 30 minutes in a vacuum of 1.33×10⁻³ Pa.

### Embodiment 10

A toluene dispersion liquid of FePt nanocrystal particles whose surfaces are protected by ethylene glycol dodecyl ether is prepared through the same process as Example 1 except that 10 ml of octadecene is added to 10 ml of ethylene glycol dodecyl ether (cf., FIG. 1, including an alkyl group with carbon number 12). After that, an aqueous dispersion of FePt nanocrystalline particles is obtained by letting the FePt nanocrystalline particles make phase transitions to a water phase. Table 1 shows the results of investigations of the composition ratios and the average particle diameter using the same methods as in Embodiment 1. It is verified by X-ray diffraction that the obtained nanocrystals experience phase transitions to the L1₀ phase, when the obtained nanocrystals are heated at 700° C. for 30 minutes in a vacuum of 1.33×10⁻³ Pa.

### Embodiment 11

A toluene dispersion liquid of FePt nanocrystal particles whose surfaces are protected by ethylene glycol dodecyl ether is prepared through the same process as Embodiment 1 except that 10 ml of tetraethyleneglycol is added to 10 ml of ethylene glycol dodecyl ether (cf., FIG. 1, including an alkyl group with carbon number 12). After that, an aqueous dispersion of FePt nanocrystalline particles is obtained by letting the FePt nanocrystalline particles make phase transitions to a water phase. Table 1 shows the results of investigations of the composition ratios and the average particle diameter using the same methods as in Embodiment 1. It is verified by X-ray diffraction that the obtained nanocrystals experience phase transitions to the L1₀ phase, when the obtained nanocrystals are heated at 700° C. for 30 minutes in a vacuum of 1.33×10⁻³ Pa.

### Embodiment 12

First, 40 mg of tris(acetylacetonato)iron (III) and 44 mg of bis(acetylacetonato)platinum (H) are added to 20 ml of diethylene glycol n-hexyl ether (cf., FIG. 1, including an alkyl group with carbon number 6) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of CoPt nanocrystals whose surfaces are protected by diethylene glycol n-hexyl ether is prepared. After 0.5 M of aqueous solution of mercaptosuccinic is added to 10 ml of the toluene dispersion liquid, it is agitated for one hour at ambient temperature. Then FePt nanocrystals shift from a toluene phase to a water phase. It is verified by the FT-IR measurement that as an organic molecule protecting the surface of the CoPt nanocrystal thus obtained, diethylene glycol n-hexyl ether is replaced by mercaptosuccinic. Table 1 shows the results of investigations of the composition ratios and the average particle diameter using the same methods as in Embodiment 1. Further, it is verified by X-ray diffraction that the obtained nanocrystals experience phase transitions to the L1₀ phase, when the obtained nanocrystals are heated at 700° C. for 30 minutes in a vacuum of 1.33×10⁻³ Pa.

### Embodiment 13

First, 40 mg of tris(acetylacetonato)iron (III) and 44 mg of bis(acetylacetonato)platinum (II) are added to 20 ml of diethylene glycol 2-methylpentyl ether (cf., FIG. 1, including an alkyl group with carbon number 6) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa, after that, the precipitations are monodispersed in toluene. In this manner, a toluene dispersion liquid of FePt nanocrystals whose surfaces are protected by diethylene glycol 2-methylpentyl ether is prepared. After 0.5 M of aqueous solution of mercaptosuccinic is added to 10 ml of the toluene dispersion liquid, it is agitated for one hour at ambient temperature. Then FePt nanocrystals shift from a toluene phase to a water phase. It is verified by the FT-IR measurement that as an organic molecule protecting the surface of the FePt nanocrystal thus obtained, diethylene glycol 2-methylpentyl ether is replaced by mercaptosuccinic. Table 1 shows the results of investigations of the composition ratios and the average particle diameter using the same methods as in Embodiment 1. Further, it is verified by X-ray diffraction that the obtained nanocrystals experience phase transitions to the L1₀ phase, when the obtained nanocrystals are heated at 700° C. for 30 minutes in a vacuum of 1.33×10⁻³ Pa.

### Reference Example 1

First, 40 mg of tris(acetylacetonato)iron (III) and 44 mg of bis(acetylacetonato)platinum (II) are added to 20 ml of diethylene glycol n-pentyl ether (cf., FIG. 1, including an alkyl group with carbon number 5) and it is heated at 300° C. for 30 minutes under argon gas atmosphere while agitated. After cooling down the reaction solution to ambient temperature, 400 ml of deionized water is added and a centrifugal separation process is performed. The precipitations are dried in a vacuum of less than or equal to 1.33×10³ Pa. After that, the precipitations are unable to be dispersed in a non-polar solvent such as toluene, or methylene chloride. It is confirmed by this reference example that when an organic compound, whose alkyl group included in its hydrophobic portion has a carbon number of 5, is used, then sufficient solvent-dispersibility is not obtained.

### Comparative Example 1

First, 40 mg of tris(acetylacetonato)iron (III) and 44 mg of bis(acetylacetonato)platinum (II), 0.4 ml of oleic acid, 0.4 ml of oleylamine, and 480 mg of 1,2-hexadecanediol are added to 4 ml of n-octyl ether and it is heated at 280° C. for 30 minutes under argon gas atmosphere while agitated. After cooling down the reaction solution to ambient temperature, 400 ml of ethanol is added and a centrifugal separation process is performed. The precipitations are dried in a vacuum of less than or equal to 1.33×10³ Pa, after that, the precipitations are monodispersed in toluene. In this manner, a toluene dispersion liquid of FePt nanocrystals whose surfaces are protected by oleic acid and oleylamine is prepared. After 0.5 M of aqueous solution of mercaptosuccinic is added to 10 ml of the toluene dispersion liquid, it is agitated for one hour at ambient temperature. However, FePt nanocrystals do not shift from a toluene phase to a water phase. It is verified by the FT-IR measurement that oleic acid and oleylamine are remaining on the surface of the FePt nanocrystal thus obtained. It is confirmed by this comparative example that when surfaces are protected by ligands which tend to form ion bonds, then the legands cannot be replaced with other organic compounds sufficiently.

TABLE 1

| Sample | Composition | Average Particle Diameter (nm) |
|---|---|---|
| Embodiment 1 | Fe₄₉Pt₅₁ | 6.8 |
| Embodiment 2 | Co₄₂Pt₅₈ | 6.3 |
| Embodiment 3 | Fe₅₁Pd₄₉ | 4.8 |
| Embodiment 4 | Co₄₅Pd₅₅ | 4.5 |
| Embodiment 5 | Co₁₀₀ | 4.1 |
| Embodiment 6 | Pt₁₀₀ | 4.3 |
| Embodiment 7 | Pd₁₀₀ | 4.0 |
| Embodiment 8 | Fe₄₁Pt₄₆Ag₁₃ | 6.4 |
| Embodiment 9 | Co₃₉Pt₄₄Pb₁₇ | 6.5 |
| Embodiment 10 | Fe₄₈Pt₅₂ | 8.3 |
| Embodiment 11 | Fe₅₁Pt₄₉ | 5.8 |
| Embodiment 12 | Fe₄₉Pt₅₁ | 6.5 |
| Embodiment 13 | Fe₅₂Pt₄₈ | 6.8 |

As it can be seen from Table 1, the average particle diameters of the alloy nanocrystalline particles obtained in respective embodiments are within the range of 4-7 nm. Also, it can be seen from Table 1 that composition ratios of the binary alloys are almost 1:1 in atomic ratio. Further, the organic compounds used in respective embodiments and the reference example are in accordance with the structural formulas shown in FIG. 1. The organic compounds can form a coordinate bond with the surface of the metal core at any of the O atoms designated as “O” in FIG. 1.

### INDUSTRIAL APPLICABILITY

A metal nanoparticle according to the present invention is a metal nanoparticle such that organic compounds having a hydrophilic portion and a hydrophobic portion is forming a coordinate bond with the surface of the nanosized core part including at least one metal element through the hydrophilic portion. After producing the metal nanoparticle, the organic compounds can be replaced with another organic compound having a functional group. The metal nanoparticle is especially useful for high density recording mediums or magnetoresistive elements.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A metal nanoparticle including:
a core portion which includes at least one metal element; and
organic compounds which adsorb onto a surface of the core portion;
wherein the organic compounds have a hydrophilic portion and a hydrophobic portion within their molecules; and
wherein the hydrophilic portion is forming a coordinate bond with the surface of the core portion through O atoms.

2. A metal nanoparticle including:
a core portion which includes at least one metal element; and
organic compounds which adsorbs onto a surface of the core portion;
wherein the organic compounds have a hydrophilic portion and a hydrophobic portion within their molecules; and
wherein the hydrophilic portion combines with the surface of the core portion through O atoms of ether groups, ketone groups, or hydroxyl groups.

3. The metal nanoparticle according to claim 1;
wherein the hydrophilic portion of the organic compounds include at least one hydroxyl group.

4. The metal nanoparticle according to claim 1;
wherein the organic compounds include R(OCH₂CH₂)ₙOH, (R: a functional group including an alkyl group, n≧1).

5. The metal nanoparticle according to claim 1;
wherein the core portion includes at least one metal element belonging to 3rd-10th groups in the 4th period of the periodic table (long form) and at least one element belonging to the platinum group elements.

6. The metal nanoparticle according to claim 5;
wherein the at least one metal element belonging to 3rd-10th groups in the 4th period is selected from at least one of Fe, Co, or Ni.

7. The metal nanoparticle according to claim 6;
wherein the core portion includes Fe and/or Co, and, Pd and/or Pt.

8. A method of fabricating the metal nanoparticle according to claim 1;
wherein the method includes:
(a) a process of preparing a solution of the organic compound by dissolving salts or complexes of the at least one metal element in the organic compounds having the hydrophilic portion and the hydrophobic portion; and
(b) a process of producing metal nanocrystals including the at least one metal element by heating the solution of the organic compounds at around 150-320° C.

9. The method according to claim 8, further comprising, following process (b);
(c) a process of precipitating and separating the metal nanocrystals by adding water to the reaction solution including the metal nanocrystals.

10. The method according to claim 8;
wherein the salts or complexes of the at least one metal element used in process (a) are a chloride, a sulfate, a nitrate, a carboxylate, an acetylacetonato complex, an ethylenediamine complex, an amine complex, a cyclopentadienyl complex, or a triphenylphosphine complex.

11. The method according to claim 8;
wherein the hydrophobic portion of the organic compounds having the hydrophilic portion and the hydrophobic portion used in process (a) include an alkyl group with a carbon number of greater than or equal to 6, and wherein the organic compounds having the hydrophilic portion and the hydrophobic portion include at least one hydroxyl group within their molecules.

12. The method of according to claim 8;
wherein the organic compounds include R(OCH₂CH₂)ₙOH, (R: a functional group including an alkyl group, n≧1).

13. The metal nanoparticle according to claim 2;
wherein the hydrophilic portion of the organic compounds include at least one hydroxyl group.

14. The metal nanoparticle according to claim 2;
wherein the organic compounds include R(OCH₂CH₂)ₙOH, (R: a functional group including an alkyl group, n≧1).

15. The metal nanoparticle according to claim 2;
wherein the core portion includes at least one metal element belonging to 3rd-10th groups in the 4th period of the periodic table (long form) and at least one element belonging to the platinum group elements.

16. The metal nanoparticle according to claim 15;
wherein the at least one metal element belonging to 3rd-10th groups in the 4th period is selected from at least one of Fe, Co, or Ni.

17. The metal nanoparticle according to claim 16;
wherein the core portion includes Fe and/or Co, and, Pd and/or Pt.

18. A method of fabricating the metal nanoparticle according to claim 2;
wherein the method includes:
(a) a process of preparing a solution of the organic compounds by dissolving salts or complexes of the at least one metal element in the organic compounds having the hydrophilic portion and the hydrophobic portion; and
(b) a process of producing metal nanocrystals including the at least one metal element by heating the solution of the organic compounds at around 150-320° C.

19. The method according to claim 18, further comprising, following process (b);
(c) a process of precipitating and separating the metal nanocrystals by adding water to the reaction solution including the metal nanocrystals.

20. The method according to claim 18;
wherein the salts or complexes of the at least one metal element used in process (a) are a chloride, a sulfate, a nitrate, a carboxylate, an acetylacetonato complex, an ethylenediamine complex, an amine complex, a cyclopentadienyl complex, or a triphenylphosphine complex.

21. The method according to claim 18;
wherein the hydrophobic portion of the organic compounds having the hydrophilic portion and the hydrophobic portion used in process (a) include an alkyl group with a carbon number of greater than or equal to 6, and wherein the organic compounds having the hydrophilic portion and the hydrophobic portion include at least one hydroxyl group within their molecules.

22. The method of according to claim 18;
wherein the organic compounds include R(OCH₂CH₂)ₙOH, (R: a functional group including an alkyl group, n≧1).
